(19) United States
(12) Patent Application Publication
(10) Pub. No.: US 2026/0295871 A1
(43) Pub. Date: Oct. 1, 2026

(54) TRANSMISSION MECHANISM AND ROBOT

(71) Applicant: HONDA MOTOR CO., LTD., Tokyo (JP)

(72) Inventor: Tetsuya ISHIKAWA, Saitama (JP)

(21) Appl. No.: 19/328,472

(22) Filed: Sep. 15, 2025

(30) Foreign Application Priority Data
Mar. 25, 2025 (JP) 2025-050062

(51) Int. Cl. B25J 19/00; B25J 9/00; B25J 17/00

(52) U.S. Cl. CPC B25J 19/0025; B25J 9/0009; B25J 17/00

(57) ABSTRACT

Provided are a transmission mechanism which exhibits flexibility at a proper position and achieves a good transmission of torque, and a robot including the transmission mechanism. A transmission mechanism for transmitting torque output from a drive device to a joint in a robot, comprises at least one shaft for torque-transmissibly connecting the drive device and the joint, wherein the shaft comprises: a straight shaft forming a straight line; and a flexible shaft that is more flexible than the straight shaft and capable of bending deformation.

### TECHNICAL FIELD

The present invention relates to a transmission mechanism for providing a torque transmission and a robot including the transmission mechanism.

### BACKGROUND ART

Patent Document 1 discloses a multi-joint device including arms rotatably connected to each other via a joint, and a rotary drive source (motor) for outputting power (torque) for rotating the arms. The power output from the rotary drive source is transmitted, via a flexible shaft, to an arm drive mechanism for rotating the arms.

Patent Document 2 discloses a multi-joint drive mechanism suitable for inspection and other operations within a reactor vessel for a fast breeder reactor. The multi-joint drive mechanism includes a first arm and a second arm connected to the first arm via a joint, where the second arm is provided with a rotating member at the tip thereof. A flexible shaft is connected to the rotating member so that torque for rotating the rotating member can be transmitted via the flexible shaft.

### PRIOR ART DOCUMENTS

### Patent Documents

Patent Document 1: JPS61-12692U

Patent Document 2: JPH06-63878A

### SUMMARY OF THE INVENTION

### TASK TO BE ACCOMPLISHED BY THE INVENTION

Due to its flexibility, a flexible shaft is less susceptible to the effect of joint drive compared to a straight shaft, which has a lower flexibility, enabling a good torque transmission. However, there is a problem that a flexible shaft is difficult to transmit torque to a distant point compared to straight shafts.

The present invention has been made in view of the problem of the prior art, and a primary object of the present invention is to provide a transmission mechanism which exhibits flexibility at a proper position and achieves a good transmission of torque, and a robot including the transmission mechanism.

### MEANS TO ACCOMPLISH THE TASK

As a solution to the above-described task to be accomplished, an aspect of the present invention provides a transmission mechanism provided in a robot which has a bendable joint, for transmission of torque output from a drive device to cause a bending motion of the joint, the transmission mechanism comprising a straight shaft forming a straight line; and a flexible shaft connected to the straight shaft, the flexible shaft that is more flexible than the straight shaft and capable of bending deformation.

As a solution to the above-described task to be accomplished, another aspect of the present invention provides a robot comprising: at least two connecting members connected to each other via a joint; a drive device for outputting torque; a transmission mechanism for transmission of torque output from a drive device; a joint motion mechanism which uses torque output from the drive device to cause a relative motion between the two connecting members, i.e., causing a joint motion of the joint, the transmission mechanism comprising a straight shaft forming a straight line; and a flexible shaft connected to the straight shaft, the flexible shaft that is more flexible than the straight shaft and capable of bending deformation.

### EFFECT OF THE INVENTION

According to the present invention, a transmission mechanism which exhibits flexibility at a proper position and achieves a good transmission of torque, and a robot including the transmission mechanism can be provided.

### BRIEF DESCRIPTION OF THE DRAWINGS

FIG. 1 is a diagram showing a robot according to an embodiment of the present invention; and

FIG. 2 is a diagram showing a joint motion mechanism according to a variant of the embodiment.

### DESCRIPTION OF THE PREFERRED EMBODIMENTS

Embodiments of a transmission mechanism and a robot including the transmission mechanism according to the present invention will be described with reference to the appended drawings.

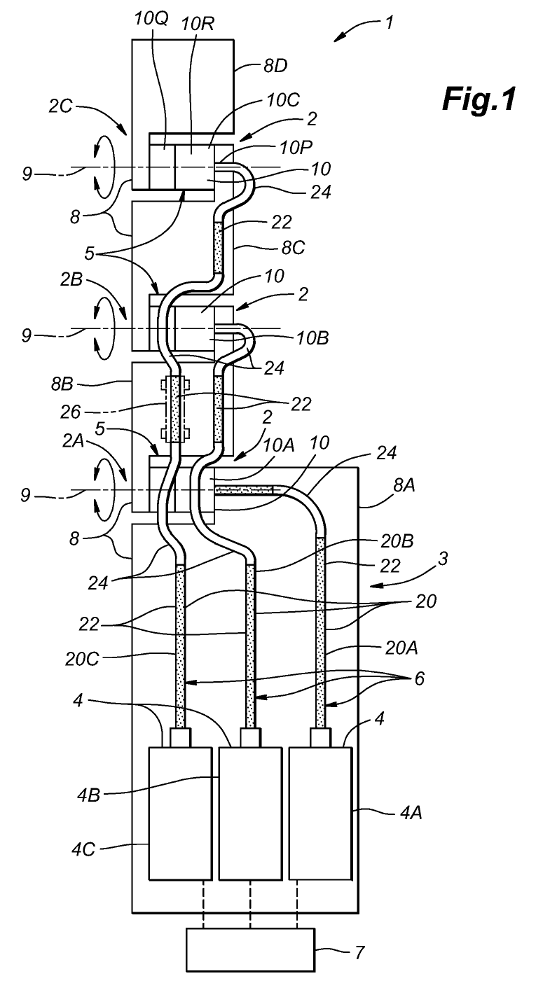

A robot 1 according to the present invention is what is called a multi-joint robot, and in the present embodiment, the robot 1 is a human-type robot (humanoid robot) that forms a human arm from the root of an upper arm to the palm. FIG. 1 shows a schematic diagram of a configuration of the robot 1 according to an embodiment of the present invention. However, FIG. 1 shows only an exemplary configuration, and embodiments of the present invention are not limited thereto.

As shown in FIG. 1, the robot 1 includes a base 3 having one or more joints 2, one or more drive devices 4 for outputting torque, one or more joint motion mechanisms 5 each using torque output from a corresponding one of the drive devices 4 to cause joint motions (bending or extending motion) of a corresponding joint 2, and one or more transmission mechanisms 6 for transmitting torque output from the drive devices 4 to the joint motion mechanisms 5. In some cases, the robot 1 may be provided with a control device 7 for controlling the operations of the drive devices 4.

The base 3 includes at least two connecting members 8 connected to each other via a corresponding joint 2. The connecting members 8 are rotatably connected to each other through the joint 2, so that the connecting members rotate about a joint axis 9 of the joint 2. In the present embodiment shown in FIG. 1, the robot 1 includes, as connecting members 8, a first connecting member 8A (also referred to as a base member), a second connecting member 8B, a third connecting member 8C, and a fourth connecting member 8D.

The first connecting member 8A forms the root of the upper arm of the robot 1.

The second connecting member 8B forms the upper arm of the robot 1. The second connecting member 8B is rotatably connected at its base end to the first connecting member 8A via a joint 2 (hereinafter referred to as a shoulder joint 2A) so that the first and second connecting members can rotate about their joint axis 9 (also referred to as a shoulder joint axis).

The third connecting member 8C forms the lower arm of the robot 1. The third connecting member 8C is rotatably connected at its base end to the free end of the second connecting member 8B via a joint 2 (hereinafter referred to as an elbow joint 2B) so that the second and third connecting members can rotate about their joint axis 9 (also referred as to an elbow joint axis).

The fourth connecting member 8D forms the palm portion of the robot 1. The fourth connecting member 8D is rotatably connected at its base end to the free end of the third connecting member 8C via a joint 2 (hereinafter referred to as a wrist joint 2C) so that the third and fourth connecting members can rotate about its joint axis 9 (also referred as to a wrist joint axis).

For each joint 2, a corresponding one of the drive devices 4 is provided for outputting torque to an output shaft to cause joint motions of the corresponding joint 2. Each of the drive devices 4 may be composed primarily of an electric motor. Although each drive device 4 is provided for a corresponding one of the joints 2, the robot may be configured such that simultaneous joint motions (bending or extending motions) of a plurality of joints 2 are caused by torque output from one drive device.

As shown in FIG. 1, in the present embodiment, the drive device 4 is configured by an electric motor and is provided for each joint 2. Specifically, the robot 1 includes, as the drive devices 4, a first drive device 4A for causing joint motions of a shoulder joint 2A, a second drive device 4B for causing joint motions of an elbow joint 2B, and a third drive device 4C for causing joint motions of a wrist joint 2C. The drive devices 4 (i.e., the first drive device 4A, the second drive device 4B, and the third drive device 4C) are each fixed to the first connecting member 8A and supported by the first connecting member 8A.

The robot 1 has a joint motion mechanism 5 for each of the joints 2. Each of the joint motion mechanisms 5 causes relative rotation between two connecting members 8 connected via the corresponding joint 2 around the corresponding joint axis 9 in response to the torque input to its input shaft, thereby causing a joint motion of the joint 2.

Each of the joint motion mechanisms 5 may constitute at least a part of the joint 2, or may be provided separately from the joint 2.

In the present embodiment, each of the joint motion mechanisms 5 includes a reducer 10 that forms the corresponding joint 2. Each of the reducers 10 is provided to extend along the corresponding joint axis 9.

Each reducer 10 includes an input shaft 10P, an output shaft 10Q, and a housing 10R. The input shaft 10P of the reducer 10 constitutes an input shaft 10P of the corresponding joint motion mechanism 5. The input shaft 10P and the output shaft 10Q are rotatably supported by the housing 10R, and the reducer 10 reduces the rotational speed input to the input shaft 10P to output high torque to the output shaft 10Q. The reducer 10 may be configured by, for example, a planetary gear mechanism, a cycloidal gear mechanism, or a harmonic drive (Registered Trademark).

In the present embodiment, each reducer 10 is a coaxial reducer in which the input shaft 10P and the output shaft 10Q are arranged on the same axis. The housing 10R of the reducer 10 is fixed to one connecting member 8, and the other connecting member 8 is fixed to the output shaft 10Q. As a result, the connecting members 8 are rotatably connected to each other. In other words, the reducer 10 forms a joint 2 that connects the two connecting members 8, and the output shaft 10Q forms the joint axis 9. When torque is applied to the input shaft 10P so that the input shaft 10P rotates, torque is output to the output shaft 10Q, causing the two connecting members 8 to rotate relative to each other around the joint axis 9.

In the present embodiment, the joint motion mechanisms 5 include a first reducer 10A that forms the shoulder joint 2A, a second reducer 10B that forms the elbow joint 2B, and a third reducer 10C that forms the wrist joint 2C.

The first reducer 10A is positioned between the first connecting member 8A and the second connecting member 8B. The housing 10R of the first reducer 10A is fixed to the first connecting member 8A, and the output shaft 10Q is fixed to the second connecting member 8B. When torque is applied to the input shaft 10P of the first reducer 10A, the second connecting member 8B rotates relative to the first connecting member 8A, causing a joint motion of the shoulder joint 2A.

The second reducer 10B is positioned between the second connecting member 8B and the third connecting member 8C. The housing 10R of the second reducer 10B is fixed to the second connecting member 8B, and the output shaft 10Q is fixed to the third connecting member 8C. When torque is applied to the input shaft 10P of the second reducer 10B, the third connecting member 8C rotates relative to the second connecting member 8B, causing a joint motion of the elbow joint 2B.

The third reducer 10C is positioned between the third connecting member 8C and the fourth connecting member 8D. The housing 10R of the third reducer 10C is fixed to the third connecting member 8C, and the output shaft 10Q is fixed to the fourth connecting member 8D. When torque is applied to the input shaft 10P of the third reducer 10C, the fourth connecting member 8D rotates relative to the third connecting member 8C, causing a joint motion of the wrist joint 2C.

However, each of the joint motion mechanisms 5 is not limited to that configured such that the reducer 10 constitutes the joint 2. For example, the two connecting members 8 may be connected to each other by a pin 12 or any other suitable component, which constitutes a joint axis 9, so that they can rotate relative to each other. In this case, the joint motion mechanism 5 may include a reducer 10 disposed at a position away from the joint axis 9, and a link mechanism 14 that causes relative rotation between the two connecting members 8 connected to each other around the joint axis 9 in response to the output of the reducer 10.

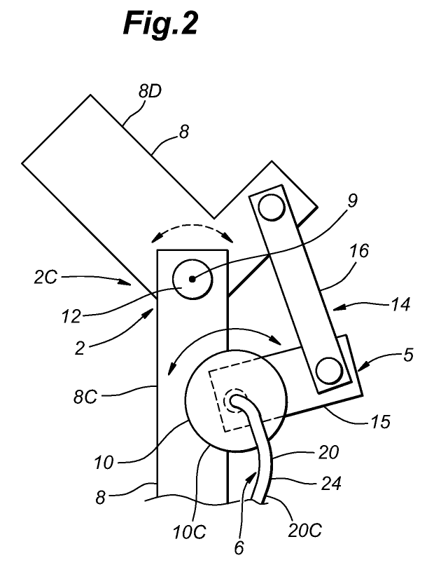

FIG. 2 is a diagram showing a configuration of the joint motion mechanism 5 in which the reducer 10 is positioned away from the joint axis 9.

In the embodiment shown in FIG. 2, the housing 10R of the reducer 10 is fixed at a position away from the wrist joint 2C of the third connecting member 8C. The link mechanism 14 includes a first link 15 fixed to the output shaft 10Q of the reducer 10, and a second link 16 rotatably connected to both the first link 15 and the fourth connecting member 8D. When the output shaft 10Q rotates, the first link 15 rotates (See a solid arrow in FIG. 2). Since the first link 15 and the fourth connecting member 8D are connected to each other by the second link 16, rotation of the first link 15 causes the fourth connecting member 8D to rotate (See a dashed arrow in FIG. 2), thereby causing a joint motion (bending or extending motion) of the wrist joint 2C.

In this configuration, the reducer 10 is placed at a position that is different from a position of the joint 2 and the joint 2 is driven with the link mechanism 14, which allows the size of the joint to be made smaller.

The transmission mechanism 6 is provided for each joint 2. Each of the transmission mechanisms 6 connects the drive device 4 and the joint motion mechanism 5, and transmits torque output from the drive device 4 to the joint motion mechanism 5 to cause the bending motion of the corresponding joint 2.

Each of the transmission mechanisms 6 includes a shaft 20 that connects the output shaft of the drive device 4 to the input shaft of the joint motion mechanism 5 (i.e., the input shaft 10P of the reducer 10). The rotation of the output shaft of the drive device 4 causes the shaft 20 to rotate, which transmits torque to the input shaft 10P of the joint motion mechanism 5. As a result, the input shaft of the joint motion mechanism 5 (i.e., the input shaft 10P of the reducer 10) rotates to cause a joint motion (bending or extending motion) of the joint 2 corresponding to the joint motion mechanism 5.

One of the shafts 20 (hereinafter referred to as a first shaft 20A) connects the first drive device 4A and the shoulder joint 2A. The first shaft 20A includes: two straight shafts 22, where one is connected to the first drive device 4A and the other is connected to the shoulder joint 2A (more specifically, the first reducer 10A, which constitutes the shoulder joint 2A), and a flexible shaft 24 connecting the two straight shafts 22.

In FIG. 1, the portions of straight shafts 22 of each shaft 20 are indicated by shadow (dot hatching), while the portion of a flexible shaft 24 is indicated without shadow (without dot hatching).

Another one of the shafts 20 (hereinafter referred to as a second shaft 20B) connects the second drive device 4B and the elbow joint 2B. The second shaft 20B includes a flexible shaft 24 that passes over a deformable position (shoulder joint 2A), and another flexible shaft 24 connected to the second reducer 10B, which constitutes the elbow joint 2B. The other portions of the second shaft 20B than these flexible shafts 24 are each formed by a straight shaft 22.

In the embodiment shown in FIG. 1, the second shaft 20B includes two straight shafts 22. One of the straight shafts 22 connects the second drive device 4B to a flexible shaft 24 arranged to pass over the shoulder joint 2A. The other straight shaft 22 is supported by the second connecting member 8B, and connects the flexible shaft 24 passing over the shoulder joint 2A, to the other flexible shaft 24 connected to the input shaft 10P of the second reducer 10B, which constitutes the elbow joint 2B.

In other words, in the second shaft 20B, one of the flexible shafts 24 is connected at one end to the input shaft 10P of the second reducer 10B and at the other end to the other straight shaft 22, the second reducer 10B constituting the elbow joint 2B.

Yet another one of the shafts 20 (hereinafter referred to as a third shaft 20C) connects the third drive device 4C and the wrist joint 2C. The third shaft 20C includes two flexible shafts 24 that pass over corresponding deformable positions (shoulder joint 2A and elbow joint 2B), and a further flexible shaft 24 connected to the third reducer 10C, which constitutes the wrist joint 2C. The other portions of the second shaft 20B than these flexible shafts 24 are each formed by a straight shaft 22.

In the embodiment shown in FIG. 1, the third shaft 20C includes three straight shafts 22. A first one of the straight shafts 22 connects the third drive device 4C to a flexible shaft 24 arranged to pass over the shoulder joint 2A. A second one of the straight shafts 22 connects the flexible shaft 24 passing over the shoulder joint 2A and a flexible shaft 24 passing over the elbow joint 2B. A third one of the straight shafts 22 connects the flexible shaft 24 passing over the elbow joint 2B, to the flexible shaft 24 connected to the third reducer 10C.

The straight shafts 22 included in the first shaft 20A, the second shaft 20B, and the third shaft 20C may each be formed by a linear member that forms a straight line.

Each of the flexible shafts 24 included in the first shaft 20A, second shaft 20B, and third shaft 20C is more flexible than the straight shafts 22 and capable of bending deformation. The straight shafts 22 may be formed, for example, of a metal rod-shaped member, while the flexible shafts 24 may be formed of a metal wire-shaped member that is more easily deformed (less rigid) than the material of the straight shafts 22.

In other cases, each of the flexible shafts 24 included in the first shaft 20A, second shaft 20B, and third shaft 20C may be formed by arranging several strands composed of steel rod (wire) or any other suitable wire rod in a strip-like manner on a single bendable core wire (core rod) and winding them in a direction forming a predetermined pitch angle relative to the axis to form a first winding layer, and then repeating the similar process, i.e., arranging several strands in a strip-like manner and winding them in the opposite direction to the previous layer to form subsequent winding layers (e.g., second and third winding layers).

Each of the straight shafts 22 included in the first shaft 20A, second shaft 20B, and third shaft 20C is rotatably inserted into an inner bore of a tubular member, i.e., an outer tube 26. The straight shaft 22 may be held by the connecting member 8 by fixing the outer tube 26 to the corresponding connecting member 8. This configuration allows the outer tube 26 to be held by the robot 1, enabling torque transmission via each of the straight shafts 22 while reducing the wobble of the straight shafts 22 caused by joint motions (bending and extending motions) of the joints 2.

As shown in FIG. 2, when the reducer 10 that forms the joint motion mechanism 5 of the wrist joint 2C is positioned away from the joint axis 9, the input shaft 10P of the reducer 10 and the straight shaft 22 supported by the connecting member 8 (the third connecting member 8C) may be connected by the flexible shaft 24.

The straight shaft 22 and the flexible shaft 24 may be connected by any method, such as mechanical coupling, metallurgical bonding, or chemical bonding, as long as power can be transmitted via the connection.

Next, the effect achieved by the so-configured transmission mechanism 6 and robot 1 will be described.

The torque output by the drive device 4 is transmitted to the reducer 10 via the shaft 20. When a flexible shaft 24 is used as the shaft 20, the shaft 20 can be made flexible, and thus follow the bending motion of the joint 2. However, this configuration, in which the shaft 20 is made flexible, causes a problem that long-distance torque transmission becomes difficult, decreasing motion responsiveness of the joint.

Using a flexible shaft 24 with high torsional rigidity as the shaft 20 is what could be a solution to this problem. However, in this case, the diameter of shaft 20 increases, which can cause a problem that the shaft hinders the bending and extending motions of the joint 2 or necessitates the larger drive device 4.

Thus, according to the embodiment of the present invention, which has been made in view of these problems, as shown in FIG. 1, the shaft 20 is composed primarily of a straight shaft(s) 22 and a flexible shaft(s) 24, which is more flexible than the straight shaft 22, is capable of bending deformation, and has lower torsional rigidity. In this configuration, a flexible member, i.e., the flexible shaft 24, can be used to form part of the shaft 20 where flexibility is required, which enables the reduction in resistance force which is potentially generated by the shaft 20 against the motion of the joint 2, preventing hindrance of the bending and extending motions of the joint 2.

Furthermore, the straight shaft 22 having higher torsional rigidity than the flexible shaft 24, can be used to form part of the shaft 20 where flexibility is not required, which enables a better torque transmission compared to the shaft 20 that is entirely formed of the flexible shaft 24, thereby enhancing the responsiveness of the joint 2 during its bending and extending motions.

In this way, the configuration, in which the straight shaft 22 having higher torsional rigidity and higher bending rigidity is used to form part of the shaft 20 where flexibility is not required, and the flexible shaft 24 having lower torsional rigidity and lower bending rigidity is used to form part of the shaft 20 where flexibility is required, enables the achievement of the transmission mechanism 6 and the robot 1 with enhanced joint motion responsiveness.

In the present embodiment, the flexible shafts 24 are used as parts of the second shaft 20B and the third shaft 20C where the second and third shafts pass over the joints 2. Thus, the parts of the second shaft 20B and the third shaft 20C where flexibility is required can be made flexible by using the flexible shaft 24.

The flexible shafts 24 are used at connections between the straight shafts 22 of the second shaft 20B and third shaft 20C and the corresponding reducers 10. Thus, the flexible shafts 24 can be used as connection parts of the second shaft 20B and third shaft 20C where the straight shafts 22 are difficult to be used therefor.

The configuration, in which the flexible shaft 24 is used only in sections where flexibility is required, maximizes the torsional rigidity of the entire shaft 20, thereby improving the overall torque transmission characteristics of the shaft 20. Furthermore, the configuration, in which the flexible shaft 24 is used only in sections where flexibility is required, enables the shaft 20 (straight shaft 22, flexible shaft 24) to be made with a smaller diameter, allowing the mechanism for transmission of torque to be made lighter.

The present invention has been described in terms of specific embodiments, but is not limited by such embodiments, and can be embodied with various modifications. Various changes may be made to features of the embodiments such as specific configuration, position, and quantity of each component or element thereof without departing from the scope of the present invention. Moreover, part or all features of the different embodiments may be combined with each other to yield another embodiment. In the above-described embodiments, not all elements included therein are essential, and some of them may be eliminated as appropriate.

In the above-described embodiments, the robot 1 is a human-type robot (humanoid robot) that forms a human arm from the root of an upper arm to the palm. In other embodiments, the robot 1 may form a human leg from the root to the toe. The robot 1 may comprise part or all of assistive robots configured to aid human's motions and reduce burdens thereon, various types of industrial robots, surgical robots, or haptic devices.

Each of the first shaft 20A, the second shaft 20B, and the third shaft 20C may be composed primarily of a plurality of link members that are arranged along a single longitudinal axis of the robot and rotatably connected to each other. Each of the link members may be configured as a rod-shaped member or as a tubular member (e.g., a cylindrical member). Each link member is rotatably connected at its end to an end of an adjacent link member, so that the two link members are rotatable about a rotation axis extending perpendicular to the longitudinal axis. Each of the first shaft 20A, the second shaft 20B, and the third shaft 20C is capable of bending deformation. Preferably, adjacent rotation axes extend in different directions. In some cases, the link members may be connected to each other by universal joints. In this case, in the first shaft 20A, second shaft 20B, and third shaft 20C, each of the straight shafts 22 may be formed by a single link member, while each of the flexible shafts 24 may be formed by a plurality of link members that are rotatably connected to each other. The longitudinal-axis length of each of the link members that form one flexible shaft 24 is preferably made shorter than the longitudinal-axis length of the link member that forms one straight shaft 22.

In the above embodiments, the robot 1 is configured so as to be capable of bending deformation at each joint 2, but the configuration of the robot 1 is not limited thereto. For example, one of the two rod-shaped link members connected at a joint 2 may be connected so as to be rotatable about the extension of the other, so that the robot 1 is rotatable at the joint 2. In this case, a flexible shaft 24 is preferably arranged to pass over the joint 2 capable of rotational deformation in a similar manner to the configuration in which a flexible shaft passes over a joint 2 capable of bending deformation.

In the above embodiments, the drive device 4 is provided on the first connecting member 8A (base member). In other cases, the drive device 4 may also be provided on other connecting members 8 (the second connecting member 8B, third connecting member 8C, or fourth connecting member 8D).

In the above embodiments, the reducer 10 is provided at each of the corresponding joints 2. In other embodiments, the reducer 10 may be coupled to each of the drive devices 4 such that the output of the reducer 10 is transmitted to the corresponding joint 2 via the shaft 20. Moreover, the reducer 10 is not essential; the output of the drive device 4 may be transmitted directly to the corresponding joint 2 via the shaft 20.

### Summary of Embodiments

The above-described embodiments of the present invention are summarized as follows.

One aspect of the present invention is to provide a transmission mechanism 6 for transmitting torque output from a drive device 4 to a joint 2 in a robot 1, comprising at least one shaft 20 for torque-transmissibly connecting the drive device 4 and the joint 2, wherein the shaft 20 comprises: a straight shaft 22 forming a straight line; and a flexible shaft 24 that is more flexible than the straight shaft 22 and capable of bending deformation.

In this configuration, the flexible shaft 24 can be provided to form part of the shaft 20 where flexibility is required, while the straight shaft 22, which enables a better torque transmission compared to the flexible shaft 24, can be provided to form part of the shaft 20 where flexibility is not required. This configuration provides a transmission mechanism 6 which exhibits flexibility at a proper position and achieves a good transmission of torque output from the drive device 4.

Preferably, the transmission mechanism of the above embodiment may be further configured such that the robot 1 is capable of bending deformation or rotational deformation at a deformable position that is different from a position of the joint 2 driven by the drive device 4, wherein the transmission mechanism comprises one or more of the shafts 20, and wherein at least one of the shafts 20 includes the flexible shaft 24 that passes over the deformable position.

This configuration enables the flexible shaft 24 to be provided at the deformable position where flexibility is required.

Preferably, the transmission mechanism of the above embodiment may be further configured such that the transmission mechanism comprises one or more of the shafts 20, and wherein at least one of the shafts 20 includes a flexible shaft 24 that is connected to the joint 2 driven by the drive device 4 and to the straight shaft 22.

This configuration enables the flexible shaft 24 to be provided at a position where the straight shaft 22 is difficult to be used to form a connection part.

Preferably, the transmission mechanism of the above embodiment may be further configured such that the straight shaft 22 is rotatably inserted into an inner bore of an outer tube 26, and wherein the outer tube 26 is held by the robot 1.

This configuration allows the wobble of the shaft 20 to be reduced.

Another aspect of the present invention is to provide a robot 1 comprising: a base 3 having at least one joint 2; a drive device 4 for outputting torque; and a transmission mechanism 6 for transmitting the torque output by the drive device 4 to the joint 2, wherein the transmission mechanism 6 comprises at least one shaft 20 for torque-transmissibly connecting the drive device 4 and the joint 2, wherein the shaft 20 comprises: a straight shaft 22 forming a straight line; and a flexible shaft 24 that is more flexible than the straight shaft and capable of bending deformation.

In this configuration, the flexible shaft 24 can be provided to form part of the shaft 20 where flexibility is required, while the straight shaft 22, which enables a better torque transmission compared to the flexible shaft 24, can be provided to form part of the shaft 20 where flexibility is not required. This configuration provides a robot b which exhibits flexibility at a proper position and achieves a good transmission of torque output from the drive device 4.

Preferably, the robot b of the above embodiment may be further configured such that the base 3 is capable of bending deformation or rotational deformation at a deformable position that is different from a position of the joint 2, wherein the transmission mechanism comprises one or more of the shafts 20, and wherein at least one of the shafts 20 (the second shaft 20B and third shaft 20C) includes the flexible shaft 24 that passes over the deformable position.

This configuration enables the flexible shaft 24 to be provided at the deformable position where flexibility is required.

Preferably, the robot 1 of the above embodiment may be further configured such that the base b includes two connecting members 8 connected to each other via a reducer 10, the reducer b forming the joint 2, wherein the transmission mechanism comprises one or more of the shafts 20, and wherein at least one of the shafts (the second shaft 20B and third shaft 20C) includes a flexible shaft b connected at one end to the reducer b and at the other end to the straight shaft 22.

This configuration enables the flexible shaft 24 to be provided at a position where the straight shaft 22 is difficult to be used to form a connection part.

Preferably, the robot b of the above embodiment may be further configured such that the base 3 comprises: two connecting members 8 rotatably connected to each other at the joint 2 so as to be rotatable around a joint axis 9; a reducer 10 provided at a position away from the joint axis 9; and a link mechanism 14 that causes the two connecting members 8 to rotate relative to each other in response to an output of the reducer 10, wherein the flexible shaft 24 is connected at one end to the reducer 10 and at the other end to the straight shaft 22.

In this configuration, the reducer 10 is placed at a position that is different from a position of the joint 2 and the joint 2 is driven with the link mechanism 14, which allows the size of the joint to be made smaller.

Preferably, the robot 1 of the above embodiment may be further configured such that the straight shaft 22 is rotatably inserted into an inner bore of an outer tube 26, and wherein the outer tube 26 is held by the base 3.

This configuration allows the wobble of the shaft 20 to be reduced.

### GLOSSARY

1 robot

2 joint

3 base

4 drive device

6 transmission mechanism

8 connecting member

9 joint axis

10 reducer

14 link mechanism

20 shaft

22 straight shaft

24 flexible shaft

26 outer tube

1. A transmission mechanism for transmitting torque output from a drive device to a joint in a robot, comprising at least one shaft for torque-transmissibly connecting the drive device and the joint, wherein the shaft comprises:
a straight shaft forming a straight line; and
a flexible shaft that is more flexible than the straight shaft and capable of bending deformation.

2. The transmission mechanism as claimed in claim 1, wherein the robot is capable of bending deformation or rotational deformation at a deformable position that is different from a position of the joint driven by the drive device,
wherein the transmission mechanism comprises one or more of the shafts, and
wherein at least one of the shafts includes the flexible shaft that passes over the deformable position.

3. The transmission mechanism as claimed in claim 1, wherein the transmission mechanism comprises one or more of the shafts, and
wherein at least one of the shafts includes a flexible shaft that is connected to the joint driven by the drive device and to the straight shaft.

4. The transmission mechanism as claimed in claim 1, wherein the straight shaft is rotatably inserted into an inner bore of an outer tube, and
wherein the outer tube is held by the robot.

5. A robot comprising:
a base having at least one joint;
a drive device for outputting torque; and
a transmission mechanism for transmitting the torque output by the drive device to the joint,
wherein the transmission mechanism comprises at least one shaft for torque-transmissibly connecting the drive device and the joint, wherein the shaft comprises:
a straight shaft forming a straight line; and
a flexible shaft that is more flexible than the straight shaft and capable of bending deformation.

6. The robot as claimed in claim 5, wherein the base is capable of bending deformation or rotational deformation at a deformable position that is different from a position of the joint,
wherein the transmission mechanism comprises one or more of the shafts, and
wherein at least one of the shafts includes the flexible shaft that passes over the deformable position.

7. The robot as claimed in claim 5, wherein the base includes two connecting members connected to each other via a reducer, the reducer forming the joint,
wherein the transmission mechanism comprises one or more of the shafts, and
wherein at least one of the shafts includes a flexible shaft connected at one end to the reducer and at the other end to the straight shaft.

8. The robot as claimed in claim 5, wherein the base comprises:
two connecting members rotatably connected to each other at a joint so as to be rotatable around a joint axis;
a reducer provided at a position away from the joint axis; and
a link mechanism that causes the two connecting members to rotate relative to each other in response to an output of the reducer,
wherein the flexible shaft is connected at one end to the reducer and at the other end to the straight shaft.

9. The robot as claimed in claim 5, wherein the straight shaft is rotatably inserted into an inner bore of an outer tube, and wherein the outer tube is held by the base.
